(19) United States
(12) Patent Application Publication
(10) Pub. No.: US 2024/0214290 A1
(43) Pub. Date: Jun. 27, 2024

(54) SCALABLE NETWORK LATENCY MEASUREMENT DESIGN IN DISTRIBUTED STORAGE SYSTEMS

(71) Applicant: VMware, Inc., Palo Alto, CA (US)

(72) Inventors: Sifan LIU, Shanghai (CN); Yu WU, Shanghai (CN); Jin FENG, Shanghai (CN); Jianan FENG, Shanghai (CN); Kai-Chia CHEN, Shanghai (CN)

(73) Assignee: VMware, Inc., Palo Alto, CA (US)

(21) Appl. No.: 18/165,499

(22) Filed: Feb. 7, 2023

(30) Foreign Application Priority Data
Dec. 21, 2022 (WO) PCT/CN2022/140631

(51) Int. Cl. H04L 43/0852; H04L 43/10

(52) U.S. Cl. CPC H04L 43/0852; H04L 43/10

(57) ABSTRACT

The disclosure provides a method for measuring network latency between hosts in a cluster. The method generally includes receiving, by a first host, a first ping list indicating the first host is to engage in a first ping round with a second host; executing the first ping round with the second host, wherein executing the first ping round comprises: transmitting first ping requests to the second host; calculating a network latency for each of the first ping requests; and determining a first average network latency between the first host and the second host based on each of the network latencies calculated; determining the first average network latency is above a threshold; determining a cause of the first average network latency being above the threshold; and selectively triggering or not triggering an alarm based on whether the cause is determined to be a hardware or software layer impact, or neither.

### CROSS-REFERENCE TO RELATED APPLICATIONS

This application claims benefit of and priority to International Patent Application No. PCT/CN2022/140631, filed Dec. 21, 2022, entitled “A SCALABLE NETWORK LATENCY MEASUREMENT DESIGN IN DISTRIBUTED STORAGE SYSTEMS,” and assigned to the assignee hereof, the contents of each of which are hereby incorporated by reference in its entirety.

### BACKGROUND

Distributed systems allow multiple clients in a network to access a pool of shared resources. For example, a distributed storage system allows a cluster of host computers to aggregate local disks (e.g., solid-state drive (SSD), peripheral component interconnect (PCI)-based flash storage, serial advanced technology attachment (SATA), or serial attached small computer system interface (SAS) magnetic disks) located in or attached to each host computer to create a single and shared pool of storage. This pool of storage (sometimes referred to herein as a “datastore” or “store”) is accessible by all host computers in the cluster and may be presented as a single namespace of storage entities (such as a hierarchical file system namespace in the case of files, a flat namespace of unique identifiers in the case of objects, etc.). Storage clients in turn, such as virtual machines (VMs) spawned on the host computers may use the datastore, for example, to store virtual disks that are accessed by the virtual machines during their operation. Because the shared local disks that make up the datastore may have different performance characteristics (e.g., capacity, input/output per second or IOPS capabilities, etc.), usage of such shared local disks to store virtual disks or portions thereof may be distributed among the VMs based on the needs of each given VM. This approach provides enterprises with cost-effective performance. For instance, distributed storage using pooled local disks is inexpensive, highly scalable, and relatively simple to manage. Because such distributed storage can use commodity disks in the cluster, enterprises do not need to invest in additional storage infrastructure.

However, performance of such distributed storage systems is often influenced by network latency between hosts. Network latency may be measured as the round-trip time (RTT) between hosts, meaning the time it takes for a data packet to travel from a source host to a destination host on the network, and for a response packet to be sent from the destination host to the source host. The RTT may be affected not only by the time the data packet takes to travel between the hosts, such as over one or more networks, but also the time it takes to process the data packet at the destination host, generate the response packet at the destination host, and process the response packet at the source host. The less network latency encountered, the faster the system is able to act on requests thereby resulting in more data getting delivered (e.g., to the application) in less time. As such, low latency may result in improved system performance. On the other hand, excessive latency can be particularly threatening to a storage environment. For example, excessive latency can create a bottleneck that can delay and/or prevent data from reaching its final destination. When this occurs, additional packets are often sent, creating more network traffic which may, in some cases, ultimately create network congestion.

Accordingly, network latency is one of the core metrics that is to be measured when monitoring distributed storage system health. Regular health checks and/or monitoring may be useful to understand whether the system, and underlying infrastructure, is capable of meeting evolving user needs, including changes in requirements and/or workloads. By consistently monitoring the network latency of the storage system, risks of the network latency creating a bottleneck for storage performance may be identified and mitigated early to help ensure peak system performance. For example, a system designed to regularly monitor network latency may raise an alarm in cases where the measured network latency is above a threshold such that appropriate action may be taken to help reduce the risk of the network latency creating a bottleneck that adversely affects storage system performance.

Network latency measured above a threshold may not always indicate a risk to the system, however. As such, in some cases, false positive alarms may be triggered creating unnecessary concern. In particular, network latency spikes may be caused by several factors, including increased central processing unit (CPU) utilization, increased network throughput due to, for example, a large number of in-process input/output (I/O) operations, an inability to satisfy a ping request (e.g., where a ping is a command-line utility that acts as a test to see if a networked device is reachable and/or for calculating RTT) due to a full and/or smaller size ping buffer of a host, issues with a network link and/or component, and/or the like. While latency resulting from issues with a network link may need immediate attention to reduce the risk of bottleneck to the system, latency caused by one or more other factors may be tolerable. However, increased latency resulting due to these additional factors may trigger false positive alarms where such alarms are not necessary.

It should be noted that the information included in the Background section herein is simply meant to provide a reference for the discussion of certain embodiments in the Detailed Description. None of the information included in this Background should be considered as an admission of prior art.

### SUMMARY

One or more embodiments provide a method for measuring network latency between hosts in a cluster. The method generally includes receiving, by a first host in the cluster, a first ping list indicating the first host is to engage in a first ping round with at least one second host in the cluster; executing, by the first host, the first ping round with the at least one second host, wherein executing the first ping round comprises: transmitting one or more first ping requests to the at least one second host; calculating a network latency for each of the one or more first ping requests; and determining a first average network latency between the first host and the at least one second host based on the network latency calculated for each of the one or more first ping requests; determining the first average network latency between the first host and the at least one second host is above a threshold; determining a cause of the first average network latency being above the threshold; and selectively triggering or not triggering an alarm based on whether the cause is determined to be a hardware layer impact, a software layer impact, or neither a hardware nor a software layer impact.

Further embodiments include a non-transitory computer-readable storage medium comprising instructions that cause a computer system to carry out the above methods, as well as a computer system configured to carry out the above methods.

### BRIEF DESCRIPTION OF THE DRAWINGS

FIG. 1 illustrates example physical and virtual network components in a networking environment in which embodiments of the present disclosure may be implemented

FIGS. 2A-2C illustrate an example workflow for performing a network health check, according to an example embodiment of the present disclosure.

FIGS. 3A-3E illustrate an example network health check performed to measure network latency between hosts in a cluster, according to an example embodiment of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Techniques for determining cluster-level network latency and its impact on distributed storage system performance is described herein. Though certain aspects are discussed with respect to distributed storage systems, the techniques discussed herein can be used with other systems that require network communications in a cluster. In particular, network health checks may be triggered for a cluster of hosts to measure network latency between each of the hosts in the cluster. The measured latency may be used to identify potential bottlenecks in the cluster. A potential bottleneck may be identified where a latency measured between at least two hosts in the cluster is above a threshold (e.g., a latency spike). As opposed to immediately triggering an alarm when high latency between at least two of the hosts is detected, techniques introduced herein may consider the impact different factors have on the measured network latency. For example, techniques herein may consider whether the latency spike is a result of a hardware layer impact (e.g., issues from physical network interfaces, routers, cables, etc.) and/or a software layer impact (e.g., increased CPU utilization, increased memory consumption, increased network throughput, etc.). While increased latency due to software layer impacts may be tolerable, increased latency due to hardware layer impacts may require immediate attention to avoid the identified bottleneck adversely affecting storage system performance. As such, in cases where a hardware layer impact is determined to be the cause of the increased latency (or in cases where a software layer impact is determined not to be the cause of the increased latency), an alarm may be triggered. On the other hand, in cases where a software layer impact is determined to be the cause of the increased latency, an additional network health check may be triggered to re-measure the network latency between one or more hosts in the cluster. In some cases, this additional health check may be performed after the software layer impact is resolved (e.g., CPU utilization decreases, etc.).

As such, the techniques described herein help to avoid the triggering of false positive alarms where the increased network latency measured by the system is not a result of issues with network-related components (e.g., physical network interface cards (NICs), switches, NIC drivers, etc.). In other words, the system may be designed to tolerate latency spikes due to other factors such as increased CPU utilization, increased network throughput, for example, due to a large number of in-progress I/Os, an inability to satisfy a ping request due to a full and/or smaller size ping buffer of a host, and/or the like. Further, by waiting until the impact these factors have on the latency are lessened, prior to performing an additional network latency measurement, a more accurate network latency measurement may be achieved to better determine whether triggering of an alarm is warranted.

In certain embodiments, performing a health check to measure network latency between each of the hosts in the cluster involves performing a ping test between each pair of hosts in the host cluster. A ping test involves a source host transmitting one or more pings, or one or more internet control message protocol (ICMP) echo requests, to a targeted host, and waiting for a response from the targeted host in response to transmitting the one or more pings. The time measured between transmitting the ping and receiving the response is an RTT. Where multiple hosts exist in the cluster, to avoid a ping flood to a single host (e.g., occurs when the single host is overwhelmed with ICMP echo-request packets from other hosts), one host in the cluster may be designated as the ping controller. The ping controller may be responsible for creating a ping scheduling for each of the hosts in the cluster such that when the network health check is performed by the hosts in the cluster, a single host is not a victim of a ping flood. By avoiding the occurrence of a ping flood, more accurate network latency measurements may be collected when performing the network health check. In particular, where a host is the recipient of multiple pings during a period of time, a ping buffer maintained by the host may become full. As such, one or more of the pings directed for the host may be dropped thereby increasing network latency. Thus, by avoiding the ping flood, techniques herein help to avoid contributing to factors which increase measured network latency and result in network latency measured for the system that may not accurately represent the network latency of the system.

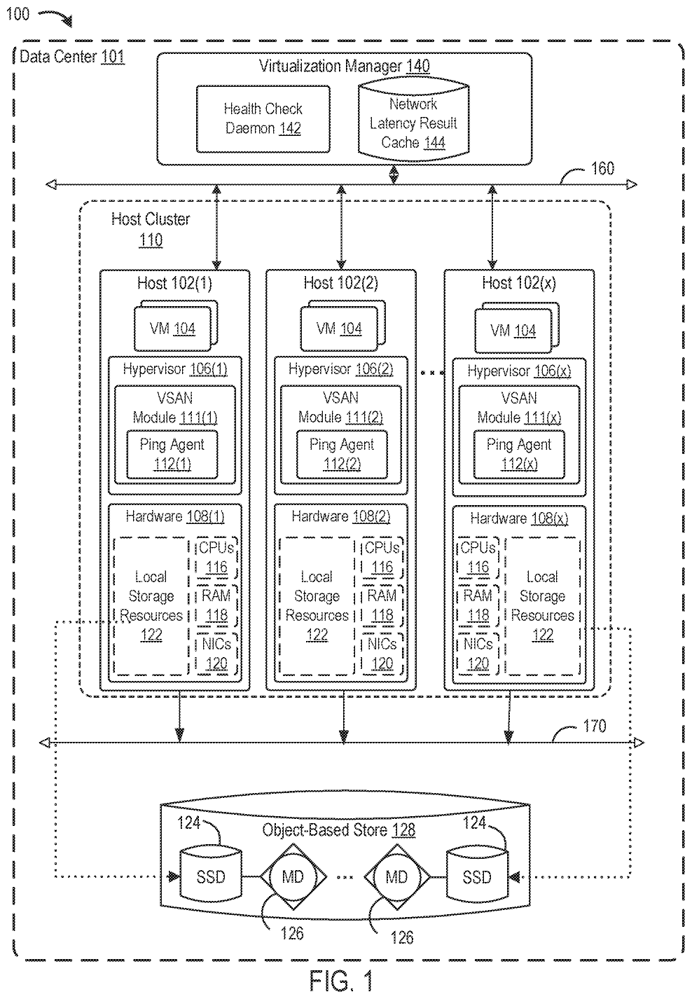

FIG. 1 illustrates example physical and virtual network components in a networking environment 100 in which embodiments of the present disclosure may be implemented.

Networking environment 100 includes a data center 101. Data center 101 includes one or more hosts 102, a management network 160, a data network 170, and a virtualization manager 140. Data network 170 and management network 160 may be implemented as separate physical networks or as separate virtual local area networks (VLANs) on the same physical network.

Host(s) 102 may be communicatively connected to data network 170 and management network 160. Data network 170 and management network 160 are also referred to as physical or “underlay” networks, and may be separate physical networks or the same physical network as discussed. As used herein, the term “underlay” may be synonymous with “physical” and refers to physical components of networking environment 100. As used herein, the term “overlay” may be used synonymously with “logical” and refers to the logical network implemented at least partially within networking environment 100.

Host(s) 102 may be geographically co-located servers on the same rack or on different racks in any arbitrary location in the data center. Host(s) 102 may be configured to provide a virtualization layer, also referred to as a hypervisor 106, that abstracts processor, memory, storage, and networking resources of a hardware platform 108 into multiple VMs 104.

Host(s) 102 may be constructed on a server grade hardware platform 108, such as an x86 architecture platform. Hardware platform 108 of a host 102 may include components of a computing device such as one or more processors (CPUs) 116, system memory (e.g., random access memory (RAM)) 118, one or more network interfaces (e.g., network interface cards (NICs) 120), local storage resources 122, and other components (not shown). A CPU 116 is configured to execute instructions, for example, executable instructions that perform one or more operations described herein and that may be stored in the memory and storage system. The network interface(s) enable host 102 to communicate with other devices via a physical network, such as management network 160 and data network 170.

Local storage resources 122 may be housed in or directly attached (hereinafter, use of the term “housed” or “housed in” may be used to encompass both housed in or otherwise directly attached) to hosts 102. Local storage resources 122 housed in or otherwise directly attached to the hosts 102 may include combinations of solid state drives (SSDs) 124 or non-volatile memory express (NVMe) drives, magnetic disks (MD) 126 or spinning disks, or slower/cheaper SSDs, or other types of storages. Local storage resources 122 of hosts 102 may be leveraged to provide an aggregate object-based store 128 to VMs 104 running on hosts 102. The distributed object-based store may be a virtual storage area network (VSAN).

A VSAN may be a logical partition in a physical storage area network (SAN). There may be different deployment options for a VSAN. Certain aspects herein are described with respect to one implementation of a VSAN, such as described in U.S. Pat. No. 10,509,708, the entire contents of which are incorporated by reference herein for all purposes, and U.S. patent application Ser. No. 17/181,476, the entire contents of which are incorporated by reference herein for all purposes. However, it should be understood that the techniques herein may also be applied to other implementations of a VSAN.

The VSAN is configured to store virtual disks of VMs 104 as data blocks in a number of physical blocks, each physical block having a physical block address (PBA) that indexes the physical block in storage. An “object” for a specified data block may be created by backing it with physical storage resources of objected-based store 128 (e.g., based on a defined policy).

The VSAN may be a two-tier datastore, storing the data blocks in both a smaller, but faster, performance tier and a larger, but slower, capacity tier. The data in the performance tier may be stored in a first object and when the size of data reaches a threshold, the data may be written to the capacity tier. SSDs may serve as a read cache and/or write buffer in the performance tier in front of slower/cheaper SSDs (or MDs) in the capacity tier to enhance I/O performance. In some embodiments, both performance and capacity tiers may leverage the same type of storage (e.g., SSDs) for storing the data and performing the read/write operations.

In an example implementation, each host 102 may include a storage management module (e.g., a VSAN module 111) in order to automate storage management workflows (e.g., create objects in object-based store 128 of the VSAN, etc.) and provide access to objects (e.g., handle I/O operations to objects in object-based store 128 of the VSAN, etc.) based on predefined storage policies specified for objects in object-based store 128. VSAN module 111 may use data network 170 to access objects in object-based store 128.

In one embodiment, VSAN module 111 is implemented as a “VSAN” device driver within hypervisor 106. In such an embodiment, VSAN module 111 provides access to a conceptual “VSAN” through which an administrator can create a number of top-level “device” or namespace objects that are backed by object-based store 128. In certain embodiments, VSAN module 111 includes a ping agent 112. Operations performed by ping agents 112 are described in detail below.

Although embodiments herein are described with respect to one implementation of VSAN, the techniques are similarly applicable to any distributed storage system. In particular, there exists different deployment options when it comes to VSANs, including deployment options where the storage and compute are not located on the same hardware. For example, a storage-only server/host SAN deployment enables storage to be deployed on one or more of hosts 102 in a cluster that are configured to only handle the storage. The cluster then shares that storage, over a network, to compute-only hosts 102. The compute-only hosts may not have a VSAN module 111 installed directly thereon but may still be able to access the storage. Thus, in such embodiments, no VSAN module 111 may exist on the hosts 102, and the ping agent 112 may be deployed elsewhere on the hosts 102, such as in hypervisor 106.

In certain embodiments, virtualization manager 140 is a computer program that executes in a server in data center 101, or alternatively, virtualization manager 140 runs in one of VMs 104. Virtualization manager 140 is configured to carry out administrative tasks for the data center, including managing hosts 102, managing (e.g., configuring, starting, stopping, suspending, etc.) VMs 104 running within each host 102, provisioning VMs 104, transferring VMs 104 from one host 102 to another host 102, transferring VMs 104 between data centers, transferring application instances between VMs 104 or between hosts 102, and load balancing VMs 104 among hosts 102 within host cluster 110. Virtualization manager 140 takes commands as to creation, migration, and deletion decisions of VMs 104 and application instances on the data center 101. However, virtualization manager 140 also makes independent decisions on management of local VMs 104 and application instances, such as placement of VMs 104 and application instances between hosts 102.

In certain embodiments, virtualization manager 140 also includes a health check daemon 142. Health check daemon 142 is a service process that runs in the background and is configured to trigger network health checks among hosts 102 in host cluster 110. In certain embodiments, a network health check involves running a ping test to (1) verify that IP connectivity exists among all hosts 102 in the host cluster 110 and (2) determine round-trip time (RTT) or latency between hosts 102. Health check daemon 142 may be in communication with one or more ping agents 112 running within VSAN modules 111 on hosts 102 to trigger the network health checks (e.g., ping tests). In certain embodiments, health check daemon 142 transmits a ping test request to a single ping agent 112, referred to herein as the “master ping agent” or “ping controller,” running on one of the hosts 102 to trigger the network health check.

As described above, a ping agent 112 may be running in VSAN module 111 (in hypervisor 106) on each host 102. Each ping agent 112 may be a master ping agent 112 or a slave ping agent 112. In certain embodiments, a single master ping agent 112 exists in host cluster 110. Master ping agent 112 is in communication with health check daemon 142 as well as with slave ping agents 112 running (in VSAN modules 111) on other hosts 102. Master ping agent 112 is responsible for determining and controlling how the ping test is to be executed by ping agents 112 in the cluster 110. For example, master ping agent 112 is configured to receive the network health check trigger (e.g., ping test trigger) from health check demon 142 and, in response to receiving this trigger, generate a ping list for each slave ping agent 112 in host cluster 110, as well as for itself. The ping list for a particular ping agent 112 may indicate which hosts 102 the ping agent 112 is expected to engage in a ping round with. A ping round may include transmitting one, two, or more pings to a targeted host 102 and waiting for a response from the targeted host 102 for each of these pings. The ping list may also indicate an order in which a ping agent 112 is expected to engage in each of these ping rounds. For example, a ping list generated for a particular ping agent 112 (of a particular host 102), may indicate that a ping agent 112 is to engage in a first ping round with a first host 102 and a second ping round with a second host 102. The ping list may also indicate that the ping agent 112 is to execute the first ping round prior to executing the second ping round. Master ping agent 112 may dispatch each of these ping lists to their respective slave ping agents 112 to initiate the ping test.

A ping agent 112 may be expected to perform each ping round within a predetermined amount of time before beginning the next ping round. If the ping agent 112 is unable to complete the ping round within the predetermined amount of time, the ping round times out and the ping agent 112 begins performing a next ping round (e.g., where another ping round with another target host 102 is indicated in a ping list for the ping agent 112) or ends performance of the ping round(s) (e.g., where the ping list does not indicate another ping round with another target host 102 to be performed by the ping agent 112). Further, in certain embodiments, each ping agent 112 may be configured to wait a threshold amount of time prior to performing a subsequent ping round. For example, two ping agents 112 that are to each perform three ping rounds may be expected to perform each ping round within 0.5 seconds (e.g., the predetermined amount of time), and each ping agent 112 may wait 0.1 second between performing each ping round. Accordingly, the first ping round that is to be performed by both ping agents 112 may begin at 0 seconds, the second ping round that is to be performed by both ping agents 112 may begin at 0.6 seconds (e.g., 0.5+0.1=0.6 seconds after beginning the ping rounds), and the third ping round that is to be performed by both ping agents 112 may begin at 1.2 seconds (e.g., 0.6+0.5+0.1=1.2 seconds after beginning the ping rounds). Thus, each ping agent 112 may begin each ping round at the same time.

In certain embodiments, master ping agent 112 may create each of the ping lists with an intention to avoid a ping flood. As described above, a ping flood occurs when a targeted device (e.g., a targeted host/ping agent 112) in host cluster is overwhelmed with ICMP echo-request packets, in some cases, causing the targeted device to become inaccessible to normal traffic. For example, when creating a ping list for ten different ping agents 112, master ping agent 112 may create each ping list such that pings of a first ping round (e.g., indicated in each ping list) that are to be transmitted by each ping agent 112, are directed for a different ping agent 112 in the cluster 110 (e.g., pings of a first ping round to be transmitted by a first ping agent 112 are to be transmitted to a second ping agent 112, pings of a second ping round to be transmitted by a second ping agent 112 are to be transmitted to a third ping agent 112, pings of a first ping round to be transmitted by a third ping agent 112 are to be transmitted to a fourth ping agent 112, etc.). Because each ping agent 112 is assigned to transmit pings to a different ping agent 112 during each ping round and because each ping agent 112 begins each round at the same time, ping floods at one or more targeted devices may be avoided.

Each slave ping agent 112 receiving a ping list from master ping agent 112, as well as master ping agent 112, may engage in the ping test. In other words, each ping agent 112 may transmit pings to targeted ping agents 112 on different hosts 102 according to an order of pings identified in each ping agent's respective ping list. Transmitting a ping may include sending an ICMP echo request to a targeted host 102. After transmitting the ping, the transmitting ping agent 112 may wait for a response from the targeted host 102. The response may be an echo reply packet transmitted by the targeted host 102. The transmitting ping agent 112 may determine how long it takes to receive a ping response from the targeted host 102, also referred to as the RTT. The RTT may be calculated for each ping that is transmitted by ping agent 112. Where multiple pings are transmitted to a same targeted host 102, ping agent 112 may determine an average RTT for the multiple pings transmitted. The RTT may be indicative of the latency between these hosts 102.

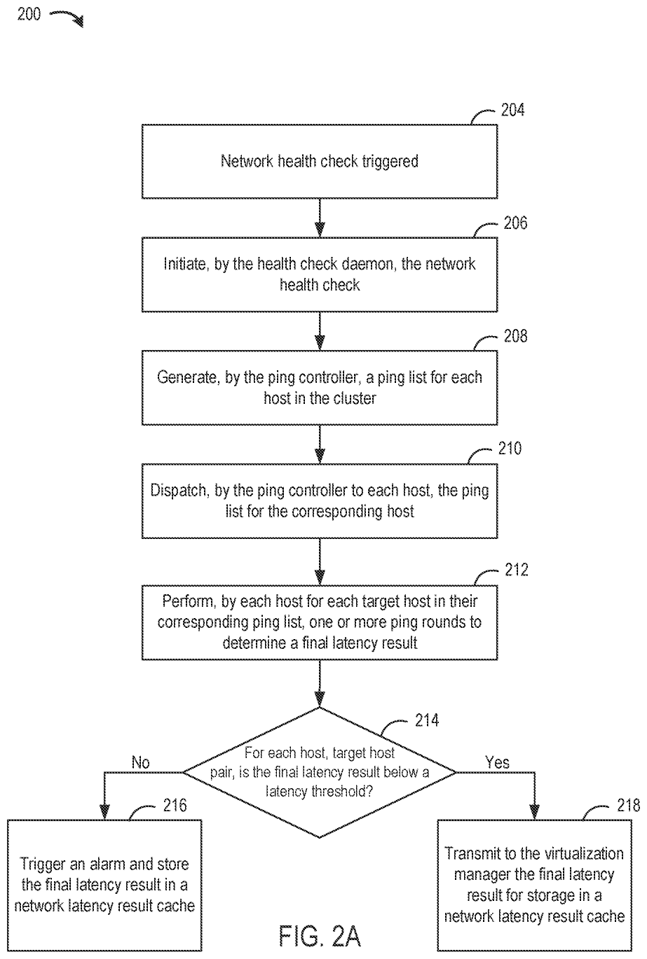

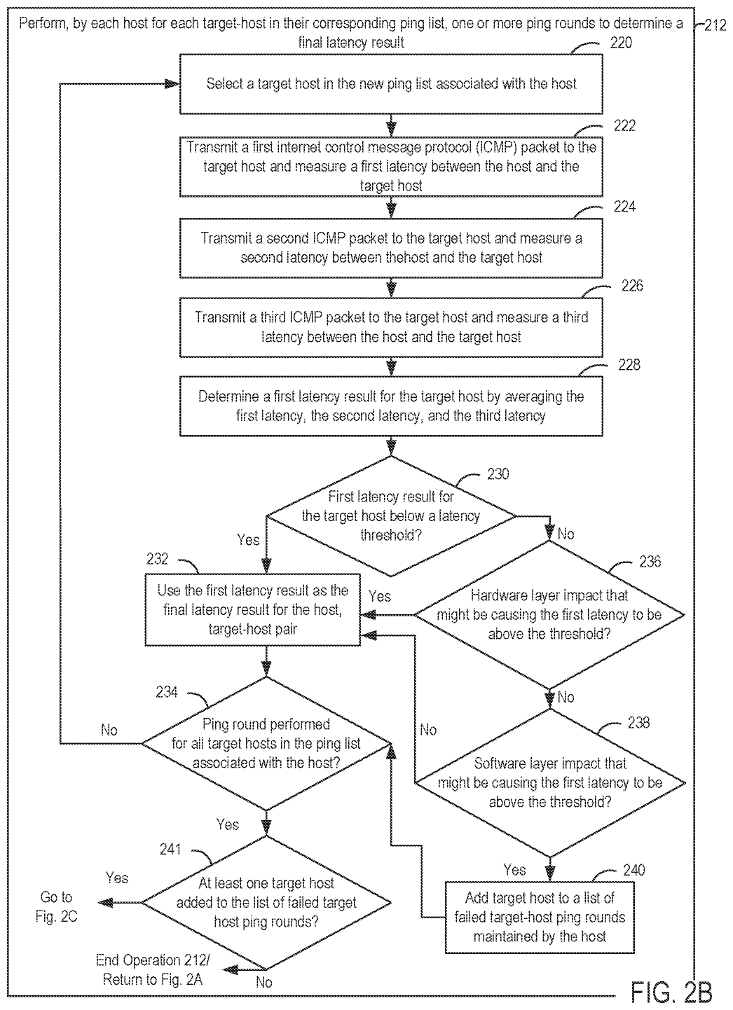

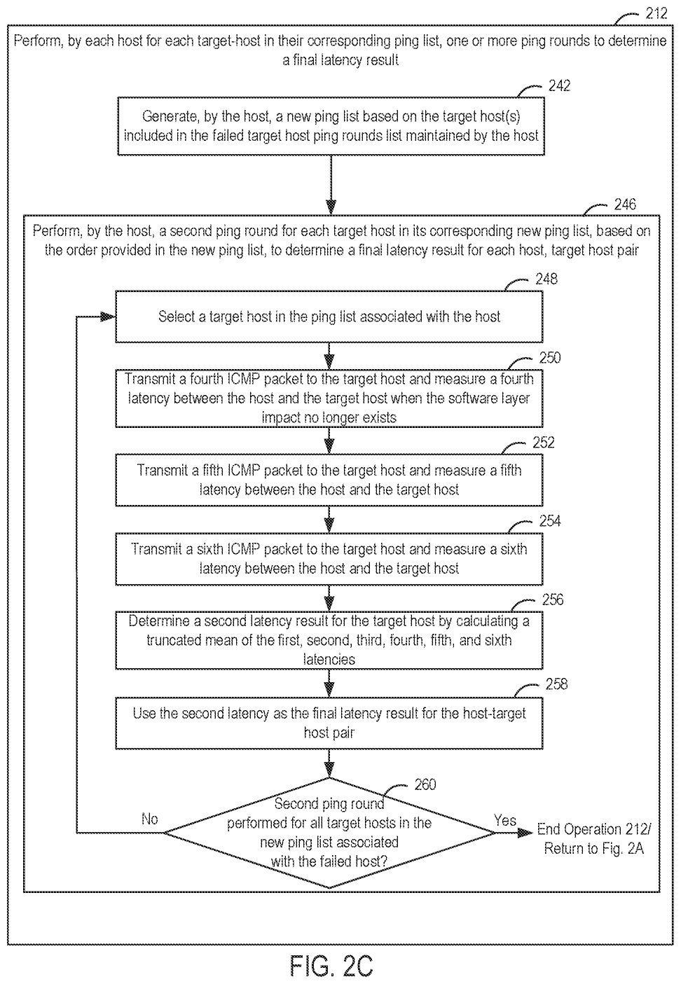

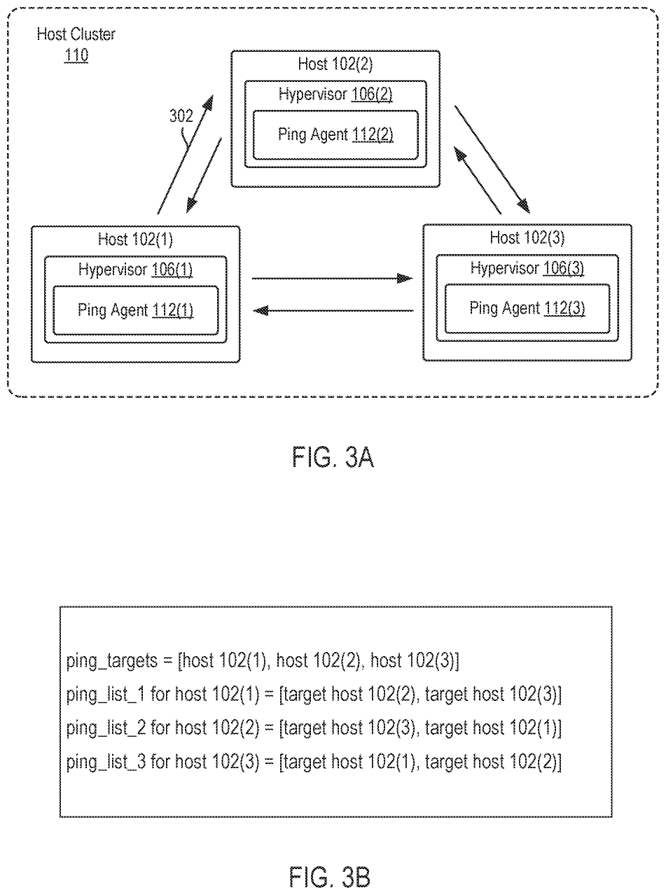

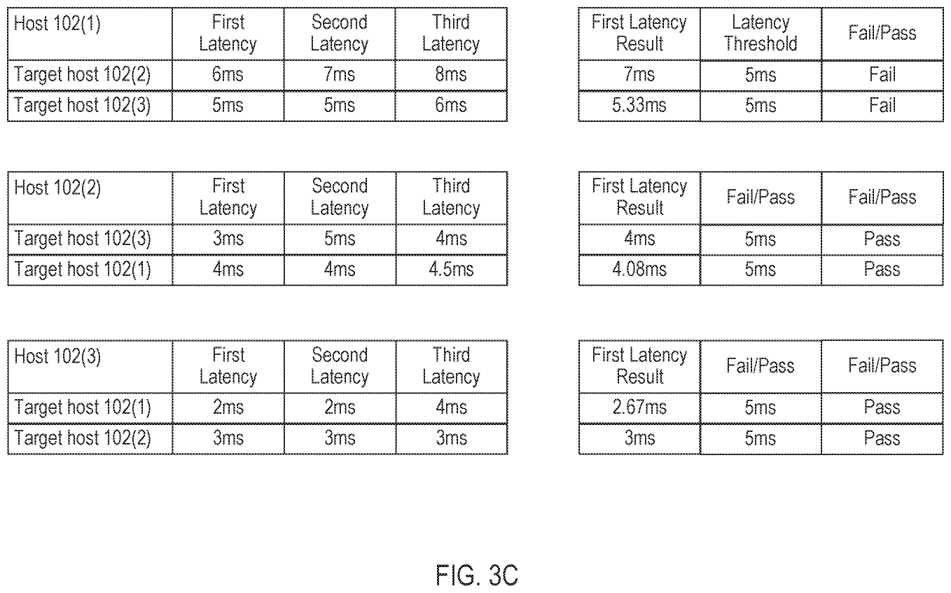

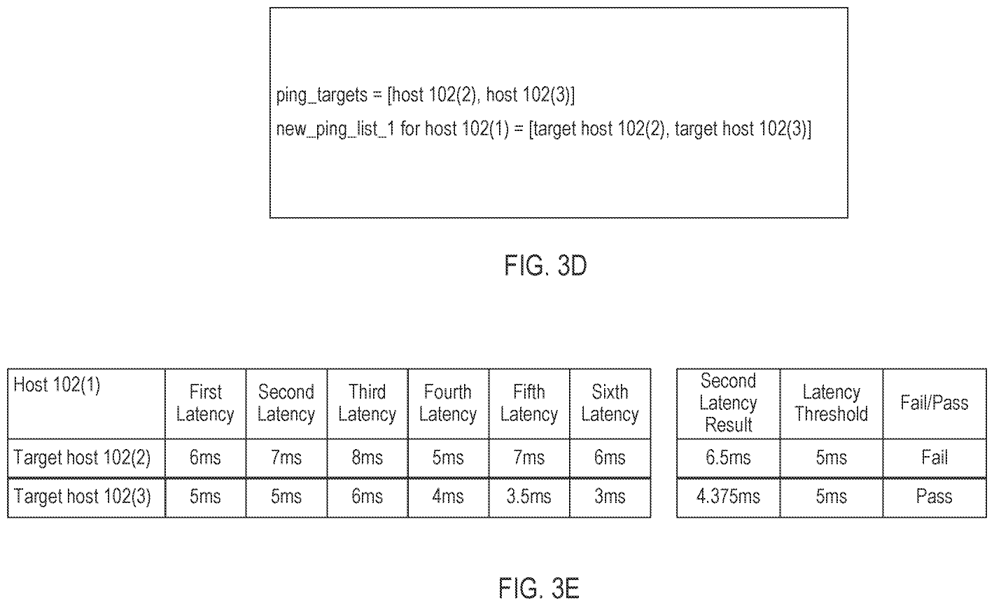

In certain embodiments, ping agents 112 are further configured to determine whether the latency between a host 102 (e.g., where ping agent 112 is running) and another host 102 is above a threshold. Where a ping agent 112 determines the latency is above a threshold, the ping agent 112 may check whether the latency is caused by issues at a hardware layer and/or a software layer of host 102 where ping agent 112 is running. For example, increased latency caused at the hardware layer may include an increase in latency due to an increase in a NIC packet drop rate where a network link is damaged and/or not working properly. Additionally, increased latency caused at the software layer may include an increase in latency due to increased CPU utilization, increased NIC throughput due a large number of in-progress I/O operations, and/or the like. Identification of a hardware layer impact causing the latency spike may prompt ping agent 112 to alert health check daemon 142, such that health check daemon 142 triggers a health check alarm. On the other hand, identification of a software layer impact causing the latency spike may prompt ping agent 112 to retry the ping test. In certain embodiments, each ping agent 112 is further configured to communicate with virtualization manager 140 the latency determined for each ping test performed with another host 102. Virtualization manager 140 may be configured to store this information in a network latency result cache 144 maintained by virtualization manager 140. Additional details regarding initiating the ping test, executing the ping test at each host 102, and determining whether increased latency is caused by a hardware layer or software layer impact are provided below with respect to FIGS. 2A-2C and FIGS. 3A-3E.

FIGS. 2A-2C illustrate an example workflow 200 for performing a network health check, according to an example embodiment of the present disclosure. The network health check described in FIGS. 2A-2C may be performed to determine cluster-level network latency for a cluster of hosts and its impact on distributed storage system performance. More specifically, the network health check described in FIGS. 2A-2C may be performed to measure network latency between pairs of host in the cluster, determine whether or not the measured network latency is a result of issues with network related components, and trigger an alarm where the measured network latency is determined to be network-component related.

For purposes of explanation, and not meant to be limiting to this particular example, workflow 200 may be described with respect to the example illustrated in FIGS. 3A-3E. In particular, FIGS. 3A-3E illustrate an example network health check performed by a cluster of hosts, including three hosts (e.g., host 102(1), host 102(2), and host 102(3)), according to operations of workflow 200 illustrated in FIGS. 2A-2C.

Workflow 200 begins, at operation 204, by the triggering of a network health check by a health check daemon 142 running in virtualization manager 140. In certain embodiments, health check daemon 142 is configured to trigger network health checks when manually instructed by a user (e.g., via a user interface (UI)). In certain embodiments, health check daemon 142 is configured to periodically trigger network health checks. With respect to the example illustrated in FIG. 3A, the health check daemon 142 may trigger a network health check that is to be performed among host 102(1), host 102(2), and host 102(3) of host cluster 110.

Workflow 200 continues, at operation 206, by health check daemon 142 initiating the network health check by transmitting a ping test request to a master ping agent 112, or ping controller, running on one of the hosts 102 in the cluster 110 to trigger the network health check. For ease of explanation, and not meant to be limiting to this particular example, it may be assumed that the ping controller is ping agent 112(1) running in hypervisor 106(1) on host 102(1), as illustrated in FIG. 3A.

Workflow 200 continues, at operation 208, by the ping controller determining and generating a ping list for each host 102 in cluster 110. As described above, a ping list generated for a particular host 102, may indicate a list of target hosts 102 for which the particular host 102 (and more specifically, a ping agent 112 of the host 102) is expected to engage in a ping round with, as well as an order that each of these ping rounds are to be executed. For example, as illustrated in FIG. 3A, host 102(1) may need to execute two ping rounds 302: one ping round 302 with host 102(2) and another ping round 302 with host 102(3). A ping round for this example may include transmitting three pings to a targeted host 102, waiting for a response from the targeted host for each of the pings, and measuring an RTT for each ping transmission/response (e.g., a first ping may be sent and a response may be received prior to the second and third pings being sent and the second ping may be sent a response may be received prior to the third ping being sent). Hosts 102(2) and 102(3) may also need to execute two ping rounds to perform the ping test.

In order to avoid a ping flood to host 102(1), host 102(2), and/or host 102(3), ping agent 112(1) (e.g., the ping controller) may generate a ping list for host 102(1), host 102(2), and host 102(3) such that each host 102 receives a single ping from another host 102 at a single time. For example, as illustrated in FIG. 3B, ping agent 112(1) may generate three ping list (e.g., one ping list for host 102(1), one ping list for host 102(2), and one ping list for host 102(3)). The ping list generated for host 102(1) indicates that host 102(1) is to engage in a ping round 302 with host 102(2) at a first time and at a second time (e.g., later in time), engage in another ping round 302 with host 102(3). The ping list generated for host 102(2) indicates that host 102(2) is to engage in a ping round 302 with host 102(3) at the first time and at the second time, engage in another ping round 302 with host 102(1). The ping list generated for host 102(3) indicates that host 102(3) is to engage in a ping round 302 with host 102(1) at the first time and at the second time, engage in another ping round 302 with host 102(2). As such, at the first time and at the second time, each targeted host 102 only engages in a single ping round 302 with another host 102. This helps to avoid one of the targeted hosts 102 from becoming a victim of a ping flood. Although for this example, a targeted host engages in only one ping round 302 at a time, in some other examples, a targeted host may engage in more than one ping round 302 at a time; however, the amount of ping rounds 302 may be limited to avoid the occurrence of a ping flood.

Workflow 200 continues, at operation 210, by the ping controller dispatching, to each host 102 in the cluster 110, their respective ping list. For the example illustrated in FIGS. 3A and 3B, ping agent 112(1) dispatches ping_list_2 to host 102(2) and ping_list_3 to host 102(3). Ping_list_1 is to be used by ping agent 112(1) when performing the ping test.

Workflow 200 continues, at operation 212, by each host 102 in the cluster performing one or more ping rounds with each target host 102 in their ping list. In particular, after performing a first ping round with a target host 102, the latency calculated based on performing the first ping round may be above a threshold. Thus, in some cases, another ping round may be performed with the same target host 102 to re-calculate the latency prior to taking further action. Details regarding performance of the first ping round and determining whether or not a second ping round is warranted, by each host 102 for each target host 102 listed in their respective ping list, are provided with respect to FIG. 2B. Details regarding performance of the second ping round (e.g., where it is warranted) are provided with respect to FIG. 2C.

Operations illustrated in FIG. 2B are performed by a single host 102 in the host cluster 110. However, each host 102 in the cluster 110 may perform the operations illustrated in FIG. 2B. For example, the operations illustrated in FIG. 2B may be performed by each of host 102(1), host 102(2), and host 102(3) illustrated in the example in FIGS. 3A-3E. For ease of explanation, the operations illustrated in FIG. 2B may be described with respect to host 102(1), in FIGS. 3A-3E, carrying out each of these operations.

At operation 220 illustrated in FIG. 2B, host 102(1) selects a target host 102 in the ping list associated with host 102(1). Host 102(1) may select host 102(2) as the target host given host 102(2) is the first target host listed in ping_list_1 associated with host 102(1).

At operation 222, host 102(1) transmits a first ICMP packet to the host 102(2), waits for a response from host 102(2), and measures a first latency between host 102(1) and host 102(2). At operation 224, host 102(1) transmits a second ICMP packet to the host 102(2), waits for another response from host 102(2), and measures a second latency between host 102(1) and host 102(2). At operation 226, host 102(1) transmits a third ICMP packet to the host 102(2), waits for another response from host 102(2), and measures a third latency between host 102(1) and host 102(2).

At operation 228, host 102(1), and more specifically ping agent 112(1) on host 102(1), determines a first latency result for host 102(2) by averaging the first latency (e.g., measured at operation 222), the second latency (e.g., measured at operation 224), and the third latency (e.g., measured at operation 226). As illustrated in FIG. 3C, the first latency measured at operation 222 is equal to 6 milliseconds (ms), the second latency measured at operation 224 is equal to 7 ms, and the third latency measured at operation 226 is equal to 8 ms. Host 102(1) determines an average latency (e.g., based on these three measured latencies) of 7 ms. Thus, the first latency result calculated as the latency between host 102(1) and host 102(2) (also referred to herein as the first latency result for the target host/host 102(2)) is equal to 7 ms.

At operation 230, ping agent 112(1) determines whether the first latency result for host 102(2) is below a latency threshold. Though not meant to be limiting to this particular example, it may be assumed that that latency threshold (e.g., for latency tolerated between hosts 102 such that an alarm does not need to be triggered) is set to 5 ms. Thus, the first latency result calculated to be 7 ms is above the latency threshold (e.g., 7 ms>5 ms). In some other cases, for example, in a remote offices and branch offices (ROBO) cluster, the latency threshold between hosts may be equal to 500 ms.

Where, at operation 230, the first latency result for host 102(2) is determined to be below the latency threshold (e.g., first latency result<5 ms), then, at operation 232, the first latency result may be used as the final latency result for the host 102(1), host 102(2) pair. In other words, an additional ping round may not need to be performed between host 102(1) and host 102(2) to re-measure the latency given the measured latency is below the threshold.

On the other hand, where, at operation 230, the first latency result for host 102(2) is determined not to be below the latency threshold (e.g., first latency result≥5 ms), at operation 236, ping agent 112(1) on host 102(1) may determine whether a hardware layer impact is the cause of the high latency being measured between host 102(1) and host 102(2) (e.g., the first latency result being above the latency threshold). As describe above, increased latency due to hardware layer impacts may require immediate attention to avoid the identified bottleneck adversely affecting storage system performance. A hardware layer impact may include issues from physical NICs, routers, cables, etc. For example, at operation 236, ping agent 112(1) may obtain a NIC packet drop rate for host 102(1) from a node in the hypervisor 106(1) on host 102(1). The node determines the NIC packet drop rate by monitoring NICs 120 in hardware 108(1). In certain embodiments, the node is a VMKernel SysInfo Interface (VSI) node in hypervisor 106(1). With this NIC packet drop rate, ping agent 112(1) may further determine whether the NIC packet drop rate for host 102(1) is above a NIC packet drop rate threshold (e.g., indicating a tolerable amount of NIC packet drops prior to triggering an alarm). In certain embodiments, the NIC packet drop rate threshold may be equal to 2.5%; thus, ping agent 112(1) may determine whether a NIC packet drop rate for host 102(1) is >2.5%. A NIC packet drop rate for host 102(1)>2.5% may be considered a hardware layer impact that is causing the high latency measurement.

Where, at operation 236, ping agent 112(1) determines that a hardware layer impact is causing the first latency result to be above the latency threshold, then, at operation 232, the first latency result may be used as the final latency result for the host 102(1), host 102(2) pair. In other words, an additional ping round may not need to be performed between host 102(1) and host 102(2) to re-measure the latency given the high latency is a result of issues with network-related components (e.g., re-measuring the network latency would likely result in the same latency being measured between the hosts 102).

On the other hand, where, at operation 236, ping agent 112(1) determines that a hardware layer impact is not causing the first latency result to be above the latency threshold, then, at operation 238, ping agent 112(1) on host 102(1) may determine whether a software layer impact is the cause of the high latency being measured between host 102(1) and host 102(2) (e.g., the first latency result being above the latency threshold). As described above, increased latency due to software layer impacts may be tolerable. A software layer impact may include increased CPU utilization, increased memory consumption, increased network throughput, etc.

For example, in certain embodiments, at operation 238, ping agent 112(1) may obtain a CPU utilization at host 102(1) from a node in hypervisor 106(1) on host 102(1). The node may be the VSI node in hypervisor 106(1) which is further configured to monitor for the CPU utilization at host 102(1). With this CPU utilization, ping agent 112(1) may determine whether the CPU utilization at host 102(1) is above a CPU utilization threshold. In certain embodiments, the CPU utilization threshold may be equal to 90%; thus, ping agent 112(1) may determine whether a CPU utilization at host 102(1) is >90%. A CPU utilization at host 102(1)>90% may be considered a software layer impact that is causing the high latency measurement. In particular, when the CPU utilization at host 102(1) becomes too high, host 102(1) may be delayed in calculating the RTT for pings transmitted to host 102(2), thereby leading to increased latency measured by host 102(1).

In certain embodiments, at operation 238, ping agent 112(1) may determine whether a network throughput utilization at host 102(1) is above a network throughput utilization threshold. In certain embodiments, the network throughput utilization threshold may be equal to 85%; thus, ping agent 112(1) may determine whether a network throughput utilization at host 102(1) is >85%. A network throughput utilization at host 102(1)>85% may be considered a software layer impact that is causing the high latency measurement. In particular, high network throughput utilization may be caused by a large number of in-progress I/O operations. Because ping packet traffic has a lower priority than other packet types, including I/O traffic, ping packet handling may be delayed. In other words, hosts 102(2) may handle in-progress I/Os before responding to a ping packet transmitted by host 102(1), and/or host 102(1) may delay calculating the RTT for the ping response due to handling I/O operations at host 102(1). Thus, the resulting latency determined by host 102(1) may be greater than the threshold due to the delays in handing the ping packet traffic.

In certain embodiments, to determine the network throughput utilization, the network throughput may be compared to network bandwidth determined for the system. For example, tools for network performance measurement and tuning, such as iPerf, may be used to determine the network bandwidth. The determined network bandwidth may be a baseline to evaluate the network throughput utilization. For example, where the network bandwidth is determined to be 800 Mbps, and the network throughput reaches 700 Mbps, the network throughput utilization may be calculated to be about 87.5% (e.g., [(700 Mbps)/(800 Mbps)]*100=87.5%).

Where, at operation 238, ping agent 112(1) determines that a software layer impact is not causing the first latency result to be above the latency threshold, then, at operation 232, the first latency result may be used as the final latency result for the host 102(1), host 102(2) pair. In other words, an additional ping round may not need to be performed between host 102(1) and host 102(2) to re-measure the latency. Because at operation 236, ping agent 112(1) determined that the latency spike was not caused by a hardware layer impact and at operation 238, ping agent 112(1) determined that the latency spike was not caused by a software layer impact, the cause of the latency spike may be unknown. As such, out of caution, the first latency result (e.g., indicating latency above the latency threshold) may be used as the final latency result for the host 102(1), host 102(2) pair such that an alarm may be triggered (e.g., described in more detail with respect to operation 216 illustrated in FIG. 2A).

On the other hand, where, at operation 238, ping agent 112(1) determines that a software layer impact is causing the first latency result to be above the latency threshold, then, at operation 240, host 102(2) is added to a list of failed target-host ping rounds. The list of failed target host ping rounds is a list individually maintained by ping agent 112(1) running on host 102(1). Further, each of ping agent 112(2) (e.g., running on host 102(2)) and ping agent 112(3) (e.g., running on host 102(3)) individually maintain their own failed target host ping rounds list. The list of failed target-host ping rounds maintained by each ping agent 112 is a list indicating which target-hosts each ping agent 112 needs to retry a ping round with such that the latency between the a host 102, where the ping agent 112 is running, and the failed target-host in the list may be re-calculated.

For the example illustrated in FIG. 3C, because the first latency result for host 102(1) and host 102(2) is above the first latency threshold (e.g., 7 ms>5 ms), ping agent 112(1) on host 102(1) may determine whether a hardware layer impact is the cause of the high latency being measured between host 102(1) and host 102(2) (e.g., at operation 236). For this example, it may be assumed that ping agent 112(1) determines that the high latency is not caused by a hardware layer impact. After making this determination, ping agent 112(1) on host 102(1) may determine whether a software layer impact is the cause of the high latency being measured between host 102(1) and host 102(2) (e.g., at operation 238). For this example, it may be assumed that ping agent 112(1) determines that the high latency is caused by a software layer impact. As such, at operation 240, ping agent 112(1) adds host 102(2) to the failed target host ping rounds list.

Subsequent to performing operation 240 or performing operation 232 (based on the latency measured by ping agent 112(1) between host 102(1) and host 102(2)), at operation 234, ping agent 112(1) determines whether a ping round has been performed for all target hosts 102 in the ping list generated for host 102(1). In this example, because only a ping round between host 102(1) and host 102(2) has been performed to measure latency between these hosts, at operation 234, ping agent 112(1) determines that not all ping rounds are complete. Thus, ping agent 112(1) again selects a new target host 102 in the ping list such that a ping round may be performed with this new target host 102. For the example illustrated in FIGS. 3A-3E, ping agent 112(1) may select host 102(3) as the new target host given this host is the next target host indicated in the ping list generated for host 102(1) (e.g., as illustrated in ping_list_1 for host 102(1) in FIG. 3B).

For this example, as illustrated in FIG. 3C, the first latency result calculated as the latency between host 102(1) and host 102(3) (also referred to herein as the first latency result for host 102(3)) is equal to 5.33 ms, which is above the latency threshold. Further, for this example, it may be assumed that ping agent 112(1) determines that this latency spike is due not due to a hardware layer impact, but is instead due to a software layer impact. Thus, host 102(3) may be added to the list of failed target host ping rounds maintained by ping agent 112(1).

After performing operations illustrated in FIG. 2B for the host 102(1) and host 102(3) pair, at operation 234, ping agent 112(1) may determine that a ping round has been performed for all target hosts 102 in the ping list associated with host 102(1) (e.g., a first ping round has been performed for the host 102(1), host 102(2) pair and a second ping round has been performed for the host 102(1) and host 102(3) pair).

At operation 241, workflow 200 continues by determining whether at least one target host has been added to the list of failed target host ping rounds (e.g., at operation 240). Where, at operation 241, it is determined that at least one target host exists in the list, workflow 200 proceeds to operations illustrated in FIG. 2C. On the other hand, where, at operation 241, it is determined that no target hosts have been added to the list, operation 212 is complete, and workflow 200 proceeds to operation 214 in FIG. 2A.

For the example illustrated in FIGS. 3A-3E, after ping agent 112(1) determines, at operation 234, that all necessary ping rounds have been performed, two target hosts will have been added to the list of failed target host ping rounds. In particular, as illustrated in the example of FIG. 3C, a measured latency for (1) host 102(2) and (2) the host 102(3) may have failed. As described above, both of these target hosts may have been added to the list of failed target host ping rounds (e.g., given the high latency was determined to be the cause of a software layer impact). Thus, because at least one target host has been added to the list of failed target host ping rounds, workflow 200 proceeds to operations illustrated in FIG. 2C. In particular, operations in FIG. 2C are performed such that a second ping round is executed for the target hosts identified in the failed target host ping rounds list maintained by ping agent 112(1).

At operation 242 illustrated in FIG. 2C, ping agent 112(1) on host 102(1) generates a new ping list for itself based on the target host(s) included in the failed target host ping rounds list maintained by ping agent 112(1). Thus, for this example, ping agent 112(1) on host 102(1) may generate a new ping list for itself indicating that a first additional ping round is to be performed with host 102(2) and a second additional ping round is to be performed with host 102(3). host 102(1) may indicate that host 102(1) is to engage in an additional ping round with host 102(2) first and engage in an additional ping round with host 102(3) second (e.g., after performing the additional ping round with host 102(2)).

At operation 246, ping agent 112(1) on host 102(1) performs a second ping round (e.g., an additional ping round) for each target host in its new ping list (e.g., based on an order provided in the new ping list). Performing the second ping round may allow a host 102, performing one or more second ping rounds, to generate a new latency measurement (e.g., a final latency result) for each target host 102 listed in its corresponding new ping list. Second ping rounds performed by host 102(1) may or may not align in time with second ping rounds performed by other hosts, such as host 102(2) and/or 102(3) where each of these hosts need to perform second ping round(s) with one or more target hosts (e.g., although in this example, only host 102(1) needs to perform the second ping round, given latency measured during first ping rounds performed by host 102(2) and host 102(3) were all below the 5 ms latency threshold as illustrated in FIG. 3C). In certain embodiments, hosts 102 may begin performance of the second ping rounds at a same offset interval such that second ping rounds for each host 102 needing to perform second ping rounds begin at the same time.

Performing a second ping round for a target host 102 includes performing operations 248-260 illustrated in FIG. 2C. To perform a second ping round with a target host, at operation 248, host 102(1) selects a target host 102 in the new ping list created by and for host 102(1). For the given example, at operation 248, host 102(1) selects host 102(2) as the target host given host 102(2) is the first target host 102 listed in new_ping_list_1 associated with host 102(1).

At operation 250, host 102(1) transmits a fourth ICMP packet to the host 102(2), waits for a response from host 102(2), and measures a fourth latency between host 102(1) and host 102(2). In some cases, host 102(1) waits a period of time prior to transmitting the fourth ICMP packet to host 102(2). In certain embodiments, the period of time that host 102(1) waits may be a period of time needed for a software layer impact, identified at operation 238 in FIG. 2B, to no longer exist and/or no longer have a significant impact on network latency between host 102(1) and host 102(2) (e.g., a period of time to allow a CPU utilization to drop below the CPU utilization threshold such that this increased CPU utilization does not skew the network latency measured by host 102(1)). In certain embodiments, the period of time that host 102(1) wait may be a preconfigured amount of time.

At operation 252, host 102(1) transmits a fifth ICMP packet to the host 102(2), waits for another response from host 102(2), and measures a fifth latency between host 102(1) and host 102(2). At operation 254, host 102(1) transmits a sixth ICMP packet to the host 102(2), waits for another response from host 102(2), and measures a sixth latency between host 102(1) and host 102(2).

At operation 256, host 102(1), and more specifically ping agent 112(1) on host 102(1), determines a second latency result for host 102(2) by calculating a truncated mean of the first, second, third, fourth, fifth, and sixth latencies measured between host 102(1) and host 102(2) (e.g., where the first, second, and third latencies were measured in the first ping round performed with host 102(2)). As illustrated in FIG. 3C, the fourth latency measured at operation 250 is equal to 5 ms, the fifth latency measured at operation 252 is equal to 7 ms, and the sixth latency measured at operation 254 is equal to 8 ms. Additionally, as described previously, the first latency that was measured at operation 222 (e.g., in the first ping round with host 102(2) is equal to 6 ms, the second latency previously measured at operation 224 is equal to 7 ms, and the third latency measured at operation 226 is equal to 8 ms. Host 102(1), and more specifically ping agent 112(1) on host 102(1), determines a truncated mean latency (e.g., based on these six measured latencies) of 6.5 ms. For example, ping agent 112(1) may remove the largest latency of 8 ms and the smallest latency of 5 ms prior to calculating the average latency between host 102(1) and host 102(2). Thus, the second latency result calculated as the latency between host 102(1) and host 102(2) (also referred to herein as the second latency result for host 102(2)) is equal to 6.5 ms. At operation 258, ping agent 112(1) uses this second latency result as the final latency result for the host 102(1), host 102(2) pair. As described below with respect to FIG. 2A, the final latency result may be used to determine whether or not an alarm is to be triggered.

At operation 260, ping agent 112(1) determines whether a second ping round has been performed for all target hosts 102 in hos 102(1)'s new ping list. In this example, because only a second ping round between host 102(1) and host 102(2) has been performed to measure latency between these hosts 102, at operation 260, ping agent 112(1) determines that not all second ping rounds (based on host 102(1)'s new ping list) are complete. Thus, ping agent 112(1) again selects a new target host 102 in the new ping list such that a second ping round may be performed with this new target host 102. For the example illustrated in FIGS. 3A-3E, ping agent 112(1) may select host 102(3) as the new target host 102 given this host is the next target host indicated in host 102(1)'s new ping list (e.g., as illustrated in new_ping_list_1 for host 102(1) in FIG. 3D). After performing operations 248-258 for host 102(3), a final latency result calculated for the host 102(1) and host 102(3) pair may be equal to 4.375 ms, as illustrated in FIG. 3E. Because the final latency result calculated for the host 102(1) and target host 102(3) pair is below the latency threshold (e.g., 4.375 ms<5 ms), it may be concluded that the high latency measured during the first ping round performed between each of these hosts 102 was due to the identified software layer impact. In particular, given the latencies measured during the second ping round were much lower thereby resulting in a truncated latency mean below the latency threshold for these hosts 102, the latencies measured during the first ping round may have been skewed by the software layer impact.

After performing operations illustrated in FIG. 2C for the host 102(1) and host 102(3) pair, at operation 260, ping agent 112(1) may determine that a second ping round has been performed for all target hosts 102 in the new ping list generated for host 102(1) (e.g., an additional ping round has been performed for the host 102(1) and target host 102(2) pair and an additional ping round has been performed for the host 102(1) and target host 102(3) pair). Thus, after operation 260, a final latency result may be determined for the host 102(1) and host 102(2) pair and the host 102(1) and host 102(3) pair. Accordingly, operation 212 may be complete for host 102(1), and workflow 200 may return to operation 214 in FIG. 2.

However, as described above, each host 102 in the cluster may perform operation 212 (e.g., perform operations 220-241 illustrated in FIG. 2B and, in some cases, perform operations 242-260 illustrated in FIG. 2C). Thus, for this example, host 102(2) and host 102(3) may each perform operation 212 to determine a final latency result for each target host in their respective ping list. As illustrated in FIG. 3C, because a first latency result calculated for each host 102(2), target host pairs is below the latency threshold, host 102(2) may only perform first ping rounds with its target hosts (e.g., listed in its respective ping list). Similarly, as illustrated in FIG. 3C, because a first latency result calculated for each host 102(3), target host pairs is below the latency threshold, host 102(3) may only perform first ping rounds with its target hosts (e.g., listed in its respective ping list). Thus, the first latency result calculated for each host 102(2), target host pair and each host 102(3), target host pair may be used as the final latency result. In particular, as illustrated in FIG. 3C, a final latency result for the host 102(2) and target host 102(3) pair is equal to 4 ms, a final latency result for the host 102(2) and target host 102(1) pair is equal to 4.08 ms, a final latency result for the host 102(3) and target host 102(1) pair is equal to 2.67 ms, and a final latency result for the host 102(3) and target host 102(2) pair is equal to 3 ms. Each of these final latency results (including final latency results calculated for host 102(1), target host pairs, as described above) may be transmitted by each ping agent 112 in host cluster 110 to virtualization manager 140.

Returning to FIG. 2A, at operation 214, each ping agent 112 may determine whether each final latency result calculated by that ping agent 112 is below the latency threshold (e.g., below 5 ms). Where, at operation 214, a final latency result is determined to be below the latency threshold, at operation 218, ping agent 112 may transmit the final latency result to virtualization manager 140 for storage of the final latency result in a network latency result cache by virtualization manager 140 (e.g., such as network latency result cache 144 illustrated in FIG. 1A).

Alternatively, where, at operation 214, a final latency result is determined to be below the latency threshold, at operation 216, ping agent 112 may indicate, to virtualization manager 140, that an alarm is to be triggered. Virtualization manager 140 may trigger an alarm in response to receiving this indication. Further, virtualization manager 140 may store the final latency result in network latency result cache 144.

In certain embodiments, final latency results measured for the host, target host pairs (e.g., stored in network latency result cache 144) in host cluster 110 may be aggregated to evaluate the overall latency of host cluster 110. In certain embodiments, the cluster level latency result depends on a percentage of failed host, target-host pings in host cluster 110. For the above example, six host, target host-pairs exist, and for the first ping round, three pings were transmitted between each host, target-host pair totaling eighteen pings (e.g., (6 host, target-host pairs)*(3 pings per host, target-host pair)=18 pings). Additionally, for the second ping round, three pings were transmitted between two host, target host pairs (e.g., the host 102(1), host 102(2) pair and the host 102(1), host 102(3) pair). Thus, six additional pings were sent between host, target host pairs in the second ping round, making the total amount of pings transmitted between host, target host pairs in host cluster 110 equal to twenty-four pings (e.g., total pings=24). A number of failed pings among these twenty-four pings was equal to ten pings (e.g., failed pings=10). In particular, as illustrated in FIG. 3C, six latency results measured by host 102(1) during the first ping rounds were greater than or equal to the latency threshold (e.g., a ping is consider to fail when the latency measured for that ping is ≥5 ms) and one latency result measured by host 102(2) during the first ping rounds was greater than or equal to the latency threshold. Additionally, as illustrated in FIG. 3E, three latency results measured by host 102(1) during the second ping rounds (e.g., fourth latency, fifth latency, and sixth latency) were greater than or equal to the latency threshold. Thus, a percentage of failed host, target host pings calculated for host cluster 110 is equal to 42% (e.g., %=[(failed pings)/(total pings)]*100=[(10 pings)/(24 pings)]*100=(0.417)*100=41.7%). In certain embodiments, alternative to, or in addition to, raising an alarm for each host, target host pair with a measured network latency greater than the latency threshold, one or more alarms may be triggered when the failed host, target host pings calculated for host cluster 110 are above a tolerable latency threshold and/or a warning latency threshold. The tolerable latency threshold may be used to trigger an alarm with the purpose of warning a user that the overall latency of the cluster needs to be monitored (when a bottleneck is more likely to occur than not). The warning latency threshold may be used to trigger an alarm with the purpose of warning a user that the overall latency of the cluster may be threatening to distributed storage system performance. In this example, the tolerable latency threshold is equal to 20% while the warning latency threshold is equal to 50%. Because the calculated percentage is above the tolerable latency threshold but below the warning latency threshold, an alarm may be triggered to inform a user of the current latency calculated for the cluster.

Final latency results measured for the host, target host pairs may represent the latency between hosts 102 at a network layer in the Open Systems Interconnection (OSI) model (e.g., a standardized framework that describes a networking system's communication functions). In certain embodiments, in addition to measuring latency at the network layer, latency at a transport layer in the OSI model may also be measured. Comparison of the latency measured at the transport layer versus latency measured at the network layer may help to determine which layer is contributing more to overall latency of the system. This may helpful in identifying a root cause of a latency spike in cases where the end-to-end latency in the system is high. For example, where the latency measured at the network layer is determined to be greater than the latency measured at the transport layer, the cause of the increased latency may be attributed to an issue with one or more network-related components, and appropriate action may be taken.

Measuring latency at the transport layer in the OSI model may be similar to measuring the latency (e.g., pin latency) at the network latency, as described above. For example, two hosts may exist in a VSAN cluster. Each host may be a reliable datagram transport (RDT) server or client. The RDT client (e.g., the first host) may transmit a packet to the RDT server (e.g., the second host) and receive a response from the RDT server in response to transmitting the packet. The RDT client may calculate the RTT, and the latency at the transport layer (e.g., latency at the RDT layer) may be measured as the calculated RTT. This latency may be known by the VSI node when making the comparison between the latency at the network latency and the latency at the transport layer.

In certain embodiments, in addition to creating ping lists for each host 102 to avoid one or more hosts 102 becoming victims of a ping flood, the ping controller may also deprioritize a ping round for a host 102 where a host 102 notifies the ping controller that its ping buffer is full. In particular, for each host 102, a host buffer size event will be registered. When the buffer for a particular host 102 is full, the host 102 may notify the ping controller. In response to receiving this notification, the ping controller may deprioritize a ping round scheduled for this host 102 host. For example, where a host 102(1) is to engage in a ping round with three different hosts (e.g., host 102(2), host 102(3), and host 102(4)), and the ping controller receives a notification that the buffer for host 102(3) is full, the ping controller when creating the ping list for host 102(1) may deprioritize the ping round for host 102(3). In particular, the ping controller may generate the ping list such that the ping round with host 102(2) and host 102(4) occur prior to the ping round with host 102(3) to avoid overwhelming the host 102(3) with pings when the ping buffer at host 102(3) is already full.

The various embodiments described herein may employ various computer-implemented operations involving data stored in computer systems. For example, these operations may require physical manipulation of physical quantities usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

1. A method for measuring network latency between hosts in a cluster, the method comprising:
receiving, by a first host in the cluster, a first ping list indicating the first host is to engage in a first ping round with one or more other hosts in the cluster, the one or more other hosts comprising a second host;
executing, by the first host, the first ping round with the one or more other hosts, wherein executing the first ping round comprises:
transmitting one or more first ping requests to the one or more other hosts;
calculating a network latency for each of the one or more first ping requests; and
determining a first average network latency between the first host and the one or more other hosts based on the network latency calculated for each of the one or more first ping requests;
determining the first average network latency between the first host and the second host is above a threshold;
determining a cause of the first average network latency being above the threshold;
if the cause is determined to be a hardware layer impact, triggering an alarm; and
if the cause is determined to be a software layer impact:
executing, by the first host, a second ping round with the second host, wherein executing the second ping round comprises:
transmitting one or more second ping requests to the second host;
calculating a network latency for each of the one or more second ping requests; and
determining a second average network latency between the first host and the second host based on the network latency calculated for each of the one or more first ping requests and the network latency calculated for each of the one or more second ping request;
determining whether the second average network latency between the first host and the second host is above the threshold; and
if the second average network latency is above the threshold, triggering the alarm.

2. The method of claim 1, further comprising:
if the cause is determined to be a software layer impact:
generating, by the first host in the cluster, a second ping list indicating the first host is to engage in the second ping round with the second host;
if the second average network latency is below the threshold, refraining from triggering the alarm.

3. The method of claim 1, wherein the first host waits until the software layer impact is minimized to execute the second ping round with the second host.

4. The method of claim 1, wherein the software layer impact comprises at least one of:
increased central processing unit (CPU) utilization,
increased memory consumption, or
increased network throughput.

5. The method of claim 1, wherein the hardware layer impact comprises problems with at least one of:
a physical network interface,
a network link,
a router, or
a cable.

6. The method of claim 1, wherein determining the hardware layer impact is the cause of the first average network latency being above the threshold comprises determining a network interface card (NIC) drop rate is above a NIC packet drop rate threshold.

7. The method of claim 1, wherein the first ping list comprises a ping list among a plurality of ping lists generated for a plurality of hosts, including the first host, by a ping controller to avoid a ping flood among the plurality of hosts.

8. A system comprising:
one or more processors; and
at least one comprising instructions that, when executed by the one or more processors, cause the system to perform operations comprising:
receiving by a first host in a cluster, a first ping list indicating the first host is to engage in a first ping round with one or more other hosts in the cluster, the one or more other hosts comprising a second host;
executing by the first host, the first ping round with the one or more other hosts, wherein executing the first ping round comprises:
transmit transmitting one or more first ping requests to second host;
calculating a network latency for each of the one or more first ping requests; and
determining a first average network latency between the first host and the one or more other hosts based on the network latency calculated for each of the one or more first ping requests;
determining the first average network latency between the first host and the second host is above a threshold;
determining a cause of the first average network latency being above the threshold;
if the cause is determined to be a hardware layer impact, triggering an alarm; and
if the cause is determined to be a software layer impact:
executing, by the first host, a second ping round with the second host,
wherein executing the second ping round comprises:
transmitting one or more second ping requests to the second host;
calculating a network latency for each of the one or more second ping requests; and
determining a second average network latency between the first host and the second host based on the network latency calculated for each of the one or more first ping requests and the network latency calculated for each of the one or more second ping request;
determining whether the second average network latency between the first host and the second host is above the threshold; and
if the second average network latency is above the threshold, triggering the alarm.

9. The system of claim 8, the operations further comprise:
if the cause is determined to be a software layer impact:
generate, generating by the first host in the cluster, a second ping list indicating the first host is to engage in the second ping round with the second host;
if the second average network latency is below the threshold, refraining from triggering the alarm.

10. The system of claim 8, wherein the first host waits until the software layer impact is minimized to execute the second ping round with the second host.

11. The system of claim 8, wherein the software layer impact comprises at least one of:
increased central processing unit (CPU) utilization,
increased memory consumption, or
increased network throughput.

12. The system of claim 8, wherein the hardware layer impact comprises problems with at least one of:
a physical network interface,
a network link,
a router, or
a cable.

13. The system of claim 8, wherein determining the hardware layer impact is the cause of the first average network latency being above the threshold comprises determining a network interface card (NIC) drop rate is above a NIC packet drop rate threshold.

14. The system of claim 8, wherein the first ping list comprises a ping list among a plurality of ping lists generated for a plurality of hosts, including the first host, by a ping controller to avoid a ping flood among the plurality of hosts.

15. A non-transitory computer-readable medium comprising instructions that, when executed by one or more processors of a computing system, cause the computing system to perform comprising:
receiving, by a first host in the cluster, a first ping list indicating the first host is to engage in a first ping round with one or more other hosts in the cluster, the one or more other hosts comprising a second host;
executing, by the first host, the first ping round with the one or more other hosts, wherein executing the first ping round comprises:
transmitting one or more first ping requests to the one or more other hosts;
calculating a network latency for each of the one or more first ping requests; and
determining a first average network latency between the first host and the one or more other hosts based on the network latency calculated for each of the one or more first ping requests;
determining the first average network latency between the first host and the second host is above a threshold;
determining a cause of the first average network latency being above the threshold;
if the cause is determined to be a hardware layer impact, triggering an alarm; and
if the cause is determined to be a software layer impact:
executing, by the first host, a second ping round with the second host, wherein executing the second ping round comprises:
transmitting one or more second ping requests to the second host;
calculating a network latency for each of the one or more second ping requests; and
determining a second average network latency between the first host and the second host based on the network latency calculated for each of the one or more first ping requests and the network latency calculated for each of the one or more second ping request;
determining whether the second average network latency between the first host and the second host is above the threshold; and
if the second average network latency is above the threshold, triggering the alarm.

16. The non-transitory computer-readable medium of claim 15, wherein when the cause is determined to be the software layer impact and not the hardware layer impact, the operations further comprise:
if the cause is determined to be a software layer impact:
generating, by the first host in the cluster, a second ping list indicating the first host is to engage in the second ping round with the second host;
if the second average network latency is below the threshold, refraining from triggering the alarm.

17. The non-transitory computer-readable medium of claim 15, wherein the first host waits until the software layer impact is minimized to execute the second ping round with the second host.

18. The non-transitory computer-readable medium of claim 15, wherein the software layer impact comprises at least one of:
increased central processing unit (CPU) utilization,
increased memory consumption, or
increased network throughput.

19. The non-transitory computer-readable medium of claim 15, wherein the hardware layer impact comprises problems with at least one of:
a physical network interface,
a network link,
a router, or
a cable.

20. The non-transitory computer-readable medium of claim 15, wherein determining the hardware layer impact is the cause of the first average network latency being above the threshold comprises determining a network interface card (NIC) drop rate is above a NIC packet drop rate threshold.
